(19) United States
(12) Patent Application Publication
(10) Pub. No.: US 2025/0035174 A1
(43) Pub. Date: Jan. 30, 2025

(54) Caliper body and brake pad assembly

(71) Applicant: BREMBO S.P.A., CURNO (IT)

(72) Inventors: Cristian CRIPPA, CURNO (IT); Mauro MAMBRETTI, CURNO (IT)

(21) Appl. No.: 18/783,769

(22) Filed: Jul. 25, 2024

(30) Foreign Application Priority Data
Jul. 27, 2023 (IT) 102023000015900

(51) Int. Cl. F16D 65/00; F16D 55/00; F16D 55/226; F16D 65/097; F16D 127/02

(52) U.S. Cl. CPC F16D 65/0075; F16D 55/2262; F16D 65/0973; F16D 2055/0016; F16D 2127/02; F16D 2250/0084

(57) ABSTRACT

The present invention relates to an assembly (1) of caliper body (2) and brake pads (3, 4). Said caliper body (2) comprises two pockets (5, 6) which receive the pads (3, 4). The caliper body (2) comprises two elongated elements (201, 202) and at least one central bridge (203) which crosses the two pockets (5, 6). Each brake pad (3, 4) comprises a support plate (11, 12) and friction material (13, 14) of predetermined radial extension (MAR). Each support plate (11, 12) comprises a support plate edge (17) having an upper edge portion (18). Each support plate (11, 12) comprises at least one protuberance (19, 20) which projects from said upper edge portion (18) and is hook-shaped defining a plate sliding surface (21) indirectly facing said rotation axis (X-X). Each support plate (11, 12) comprises at least one pad support surface (22) arranged substantially orthogonal to said circumferential direction (C-C) which extends over at least half of the predetermined radial extension (MAR) of said friction material (13, 14). Said central bridge (203) comprises at least two central bridge protuberances (23) separated by a central bridge window (27) which form caliper body sliding surfaces (24) which face said plate sliding surfaces (21). The caliper body (2) comprises at least two caliper support surfaces (25, 26) which face said pad support surfaces (22).

### FIELD OF THE INVENTION

The present invention relates to an assembly of caliper body and brake pads.

In addition, the present invention relates to a method of assembling a brake pad to a brake caliper.

### BACKGROUND ART

In a disc brake, the brake caliper is generally arranged straddling the external peripheral margin of a brake disc, adapted to rotate about a rotation axis (X-X) defining an axial direction (A-A). In a brake disc, there are also defined a radial direction (R-R) substantially orthogonal to said axial direction (A-A), and a circumferential direction (C-C) orthogonal to both said axial direction (A-A) and said radial direction (R-R), as well as a tangential direction (T-T) locally, or rather punctually, i.e., in an intersection point of an axial and a radial direction, orthogonal to both said axial direction (A-A) and said a radial direction (R-R).

Current brake calipers for disc brake exhibit various technical problems related to the presence of pins, typically made of steel, which are screwed or driven into the calipers and are intended to slide and support the pads when a braking action is required.

In particular, there is evidence of breakage and/or slippage of said pins from the appropriate seats due to heavy stresses. Moreover, the presence of such pins causes a general lack of space, usable for example to place efficient masses for improving performance from the NVH point of view, or to place efficient springs for minimizing residual torques, or even to place various types of sensors (e.g., wear indicators). The presence of the aforementioned steel pins also makes the calipers excessively heavy.

Finally, the shape of the current disc brake calipers requires an operator to disassemble the brake caliper itself to perform the pad replacement operation, thus making some brake system maintenance operations difficult and time-demanding.

There are several patent documents describing pin-less disc brake calipers for the sliding of the pads.

For example, patent documents U.S. Pat. Nos. 4,200,173 and 4,823,920 describe a floating caliper slidingly supported on pins fixed to an anchor plate, in turn said anchor plate is fixed to a fixed part of the vehicle. Such an anchor plate has two arms which extends axially and support the pad and the pad support plate in a sliding manner by engaging guide grooves made on the pad support plate with guide rails made on said anchor plate.

Moreover, document EP135696 describes a floating caliper, having a bridge provided with an opening defined by a radially arranged edge and two stepped edges circumferentially spaced apart and which extend axially. The document further describes a pad plate having an upper tab provided with pairs of support surfaces or shoulders which support the radially outer portion of the pad on the steps of the aforementioned stepped edges.

Other solutions are known from U.S. Pat. Nos. 4,498,564A, 3,605,956A, GB1585159A, CN204200914U, U.S. Pat. Nos. 4,200,173A, 4,823,920, EP0135696A1, U.S. Pat. No. 4,046,233A, JP2001323953A, GB1506709A, EP0248385A1 and FR2517399A1.

In particular, GB1585159A shows a disc brake assembly comprising a rotating disc and caliper straddling the peripheral edge of the disc and comprising a radial opening through which friction pads can be installed in the brake on opposite sides of the disc. Each friction pad has opposite sides defining a friction face for the engagement with the disc and a thrust-receiving face for receiving a force from the brake application means and having two laterally spaced radial fins which protrude from the outer edge thereof, respectively, the lateral dimension of which between the inner faces of the fins at the inner ends thereof is greater than the lateral dimension between the inner faces of the fins at the outer ends thereof to define a pair of spaced recesses. The caliper is provided, on opposite sides of the radial opening, with skirts in which pairs of recesses corresponding to the recesses in the pads are provided, as well as side edges of a blade spring extending beyond the peripheral edge of the disc which is received in the recesses of the pads. The side edges of the blade spring, when it is not biased, are spaced apart by a greater distance than the distance between the recesses of the fins so that the spring is biased to the position of use thereof.

This solution has significant drawbacks in using a leaf spring which is pretensioned and keeps the pads preloaded, both in assembly and especially in use, creating undesirable jamming in the pad movement.

In addition, the described documents of the prior art provide floating calipers having sliding surfaces orthogonal to further surfaces intended to discharge the braking torque, said sliding surfaces being adjacent to said further surfaces.

Still further, none of the known solutions, albeit having a fixed caliper, provide solutions that are simple to make, have a small number of components, and are reliable in operation.

### Solution

The present invention aims at providing a caliper body and brake pad assembly.

These and other objects are achieved by an assembly according to claim 1 and

by a method according to claim 16.

Some advantageous embodiments are the subject of the dependent claims.

By virtue of the suggested solutions, it is possible to have machined sliding or support surfaces obtained directly on the caliper body and having sliding surfaces suitable for the sliding of pad support plates for disc brakes only.

The invention further involves the creation of appropriate support plate protuberances, or support hooks, at the upper or radially outer part of the pad support plate, having support surfaces which can slide on said machined surfaces.

In particular, such support hooks are made at a central portion of said pad support plates, so that they can couple to such machined surfaces, which are preferably made in the central bridge zone, or above the pad supports. Such machined surfaces on the caliper body have an extension such as to allow said support surfaces of the pad support plate to slide so that the pad can switch from a resting, non-worn position, in which the pad is not in contact with a brake disc and away therefrom with the support plate thereof, to an operating, maximum-wear position, in which the pad is in contact with the brake disc because a braking action has been required by a user and having the friction material worn off, but without the occurrence of breakage and/or slippage of said pad support plates from said machined surfaces.

The sizing of such sliding surfaces is studied by considering the load that such surfaces must bear. Specifically, the sizing of the sliding surface is done by considering the weight of the pad, the acceleration reached during a braking action, and the sliding surface of said support hooks made on said pad support plate.

The sliding surface of said support hooks is preferably flat, so as to minimize the pressure applied by said support plate to said sliding surface.

An alternative embodiment provides a sliding surface of said support hooks of a punctual or linear type.

The suggested assembly is designed so that, unlike the documents of the prior art, the braking torque is discharged onto the radial support surfaces, in the figures shown as vertical and side surfaces of said support plates, placed at distal end positions with respect to the position in which the machined surfaces are made on the caliper body. This ensures a sufficiently large braking torque discharge surface to minimize the likelihood of wear marks (nicks) occurring on said support surface due to said pad support plates sliding thereon.

By virtue of the suggested solutions, it is possible to have a disc brake braking system which comprises a brake caliper having a pair of pads adapted to apply a braking action to the surface of a disc. Each pad of said pair of pads is supported by a pad support plate. Said braking system features said brake caliper which includes central bridge protuberances with machined surfaces obtained directly on the caliper body and having caliper sliding surfaces suitable for the sliding of pad support plates for disc brakes only. Said pad support plate includes at least one pair of pad protuberances, or support hooks, placed at the upper part of said pad support plate. Each of said support hooks comprise plate sliding surfaces adapted to slide on said caliper sliding surfaces of said machined surfaces.

### FIGURES

Further features and advantages of the invention will become apparent from the description provided below of preferred exemplary embodiment thereof, given by way of non-limiting indication, with reference to the accompanying drawings, in which:

FIG. 1 shows an axonometric view from the outer radial side, i.e., facing the axis of the brake disc, of a caliper comprising an assembly of caliper body and brake pads according to the invention, in which said caliper is placed straddling the braking band of a brake disc;

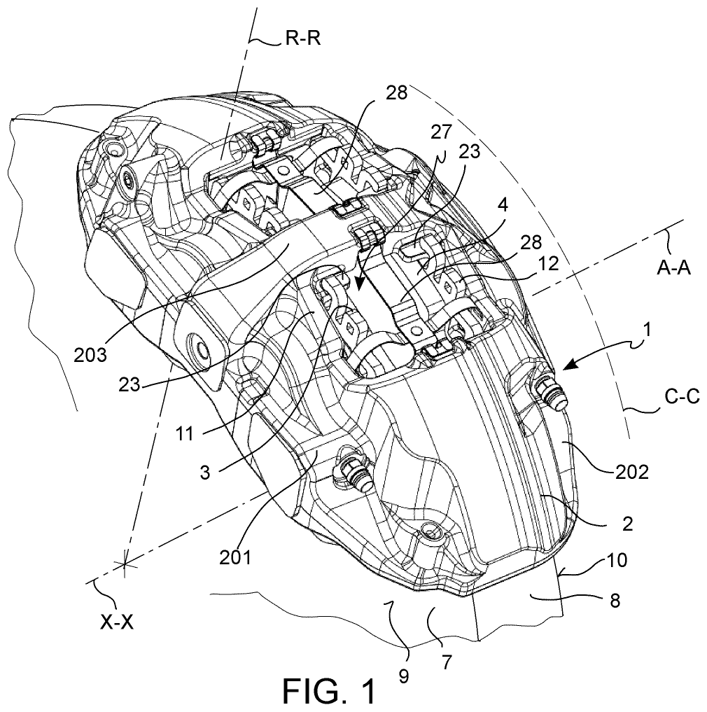

FIG. 2 shows an axonometric view of the caliper in FIG. 1 free from the brake disc and viewed from the inner radial side, i.e., facing away from the axis of the brake disc to which such a caliper is arranged in a straddling fashion;

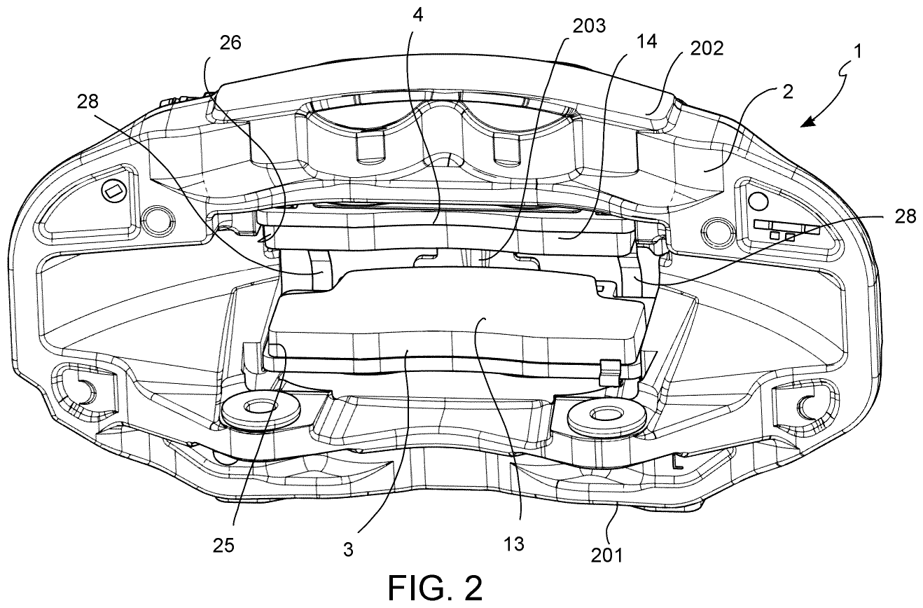

FIG. 3 shows an orthogonal top view of the caliper in FIG. 1, i.e., in radial direction looking toward the axis of the brake disc to which said caliper is arranged in a straddling fashion;

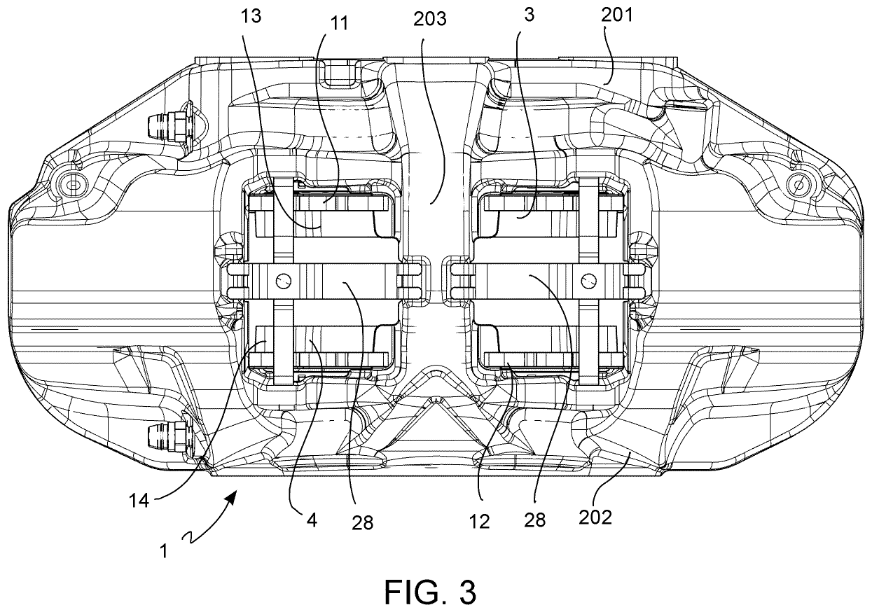

FIG. 4 shows an axonometric view of the pair of brake pads of the caliper in FIG. 1 with which two band springs are associated and on the plate thrust surfaces of which an anti-vibration, load distribution, and thermal shear plate is placed;

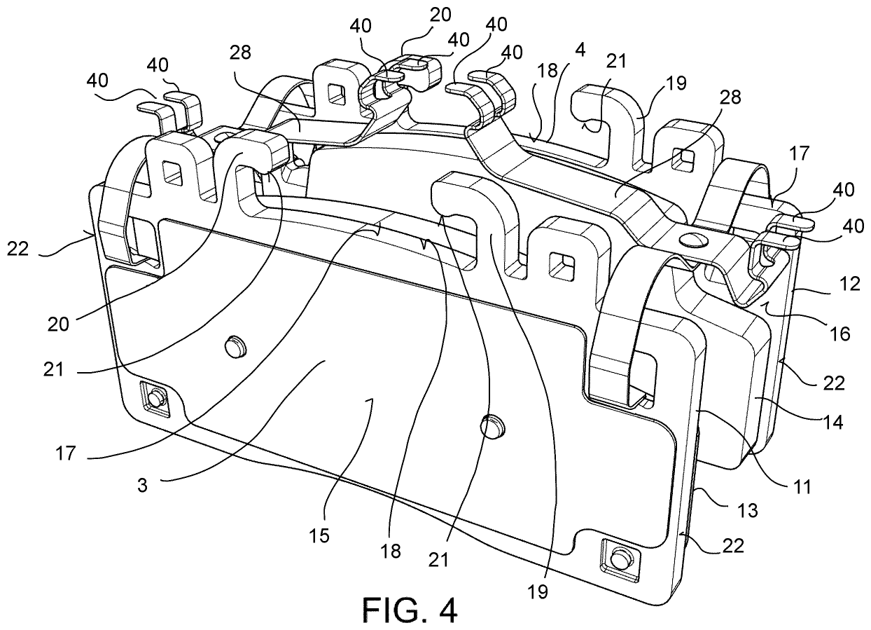

FIG. 5 shows an axonometric view of the pair of brake pads in FIG. 4 without the associated band springs;

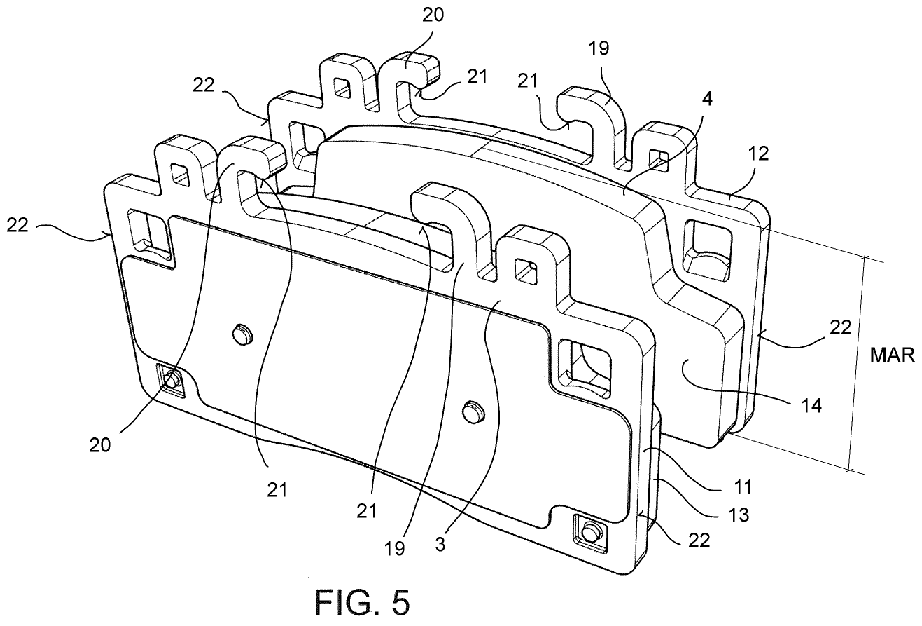

FIG. 6 shows an axonometric view of a plate of a brake pad in FIG. 4;

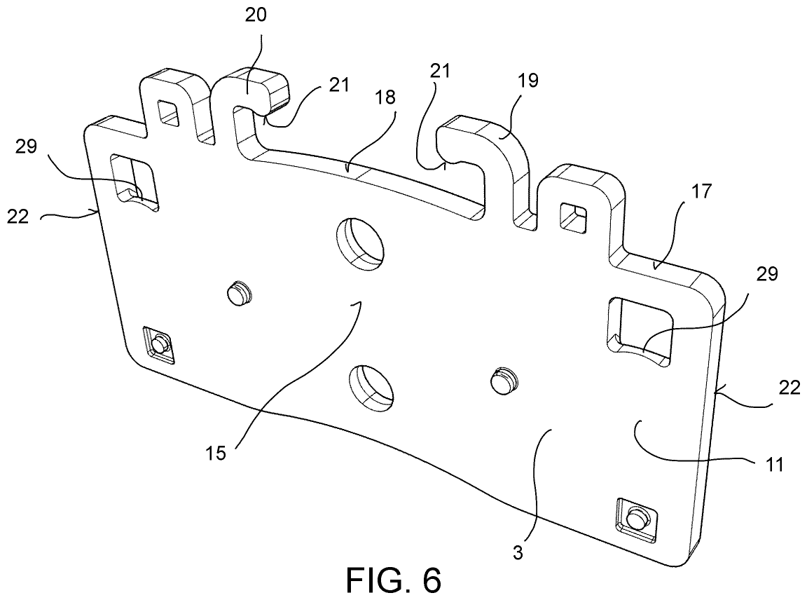

FIG. 7 shows an axonometric view of the caliper body in FIG. 1 alone;

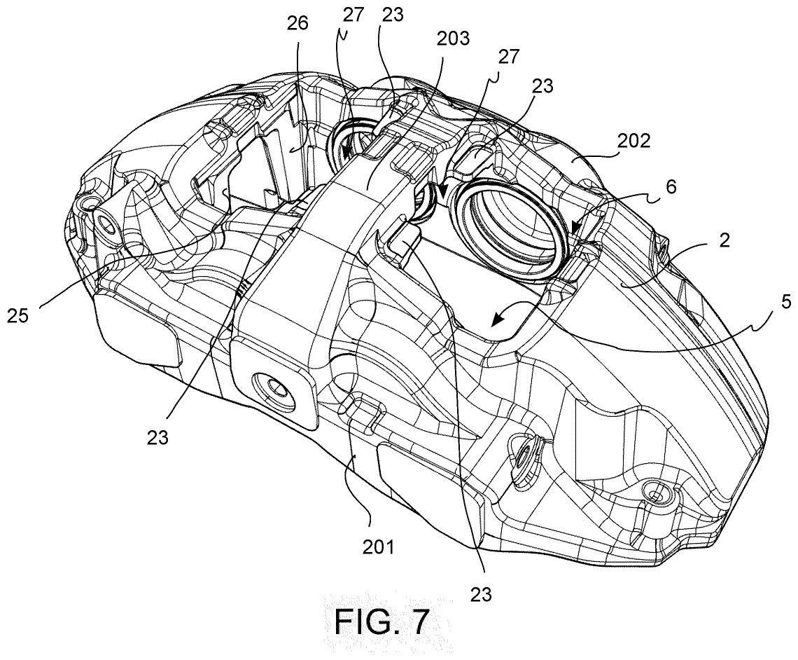

FIG. 8 shows an axonometric view, sectioned along the centerline taken along a plane containing a radial and a circumferential direction, of the caliper body in FIG. 7;

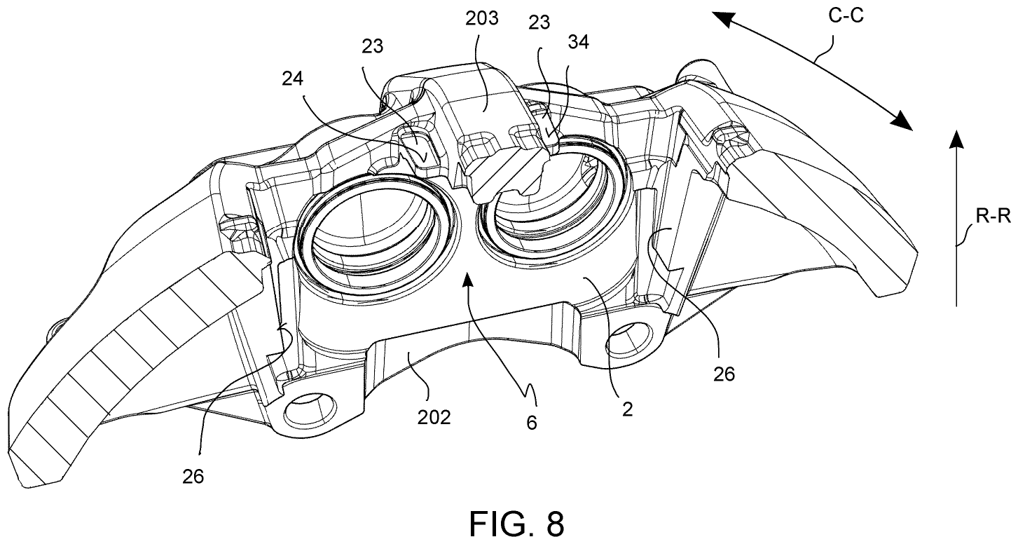

FIG. 9 shows an axonometric view, sectioned close to the caliper support surfaces of the pockets adapted to accommodate the pads, taken along a plane containing the radial and axial directions, of the caliper body in FIG. 7;

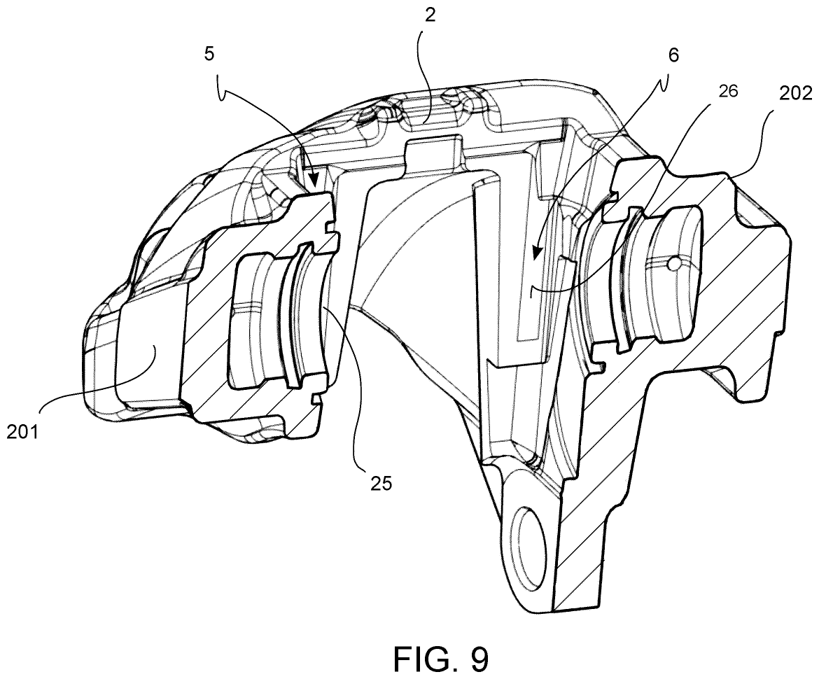

FIG. 10 shows an axonometric view, sectioned close to the central bridge taken along to a plane containing the radial and axial directions, of the caliper body in FIG. 7;

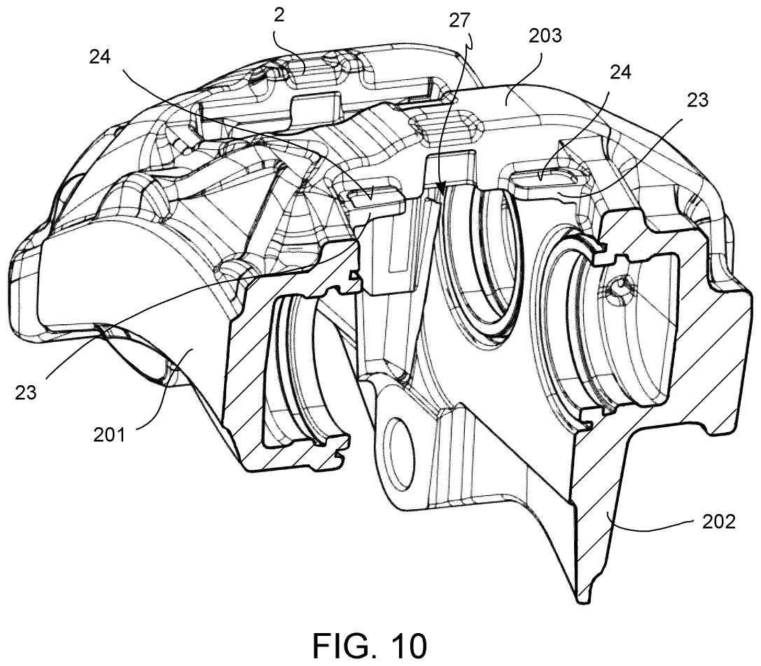

FIG. 11 shows an axonometric view of one of the band springs adapted to bias the pair of brake pads of the caliper in FIG. 1;

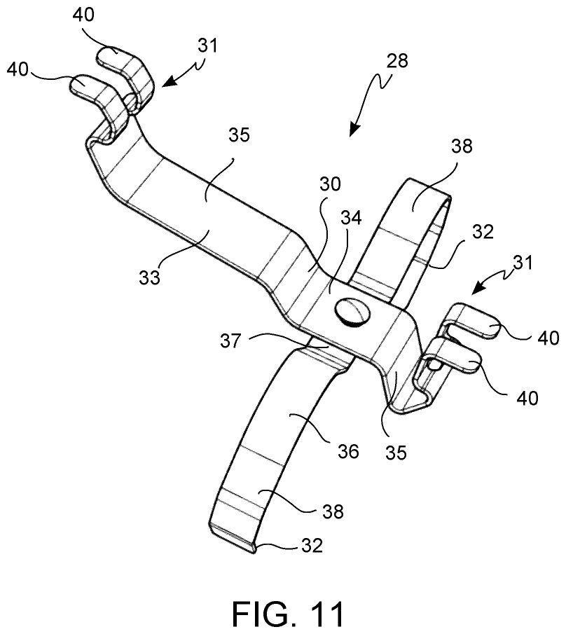

FIG. 12 shows an axonometric view of the pair of band springs adapted to bias the pair of brake pads of the caliper in FIG. 1;

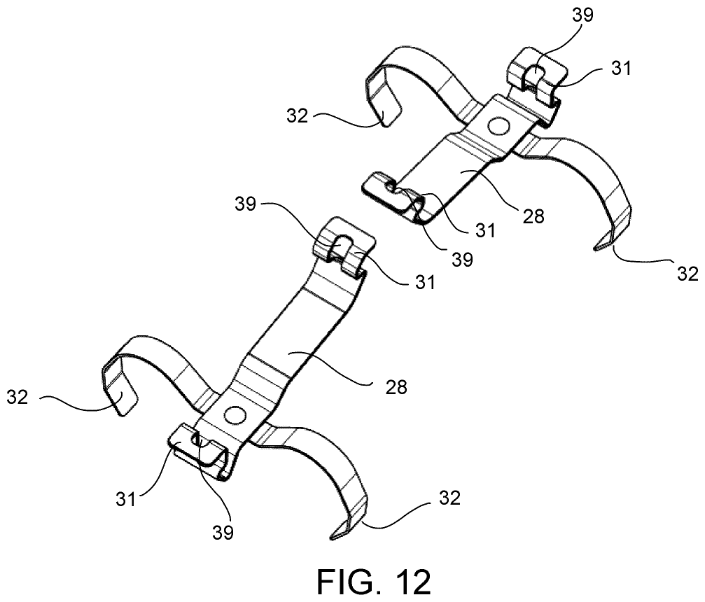

FIG. 13 shows three different steps of assembling a brake pad in a caliper body of a caliper according to FIG. 1;

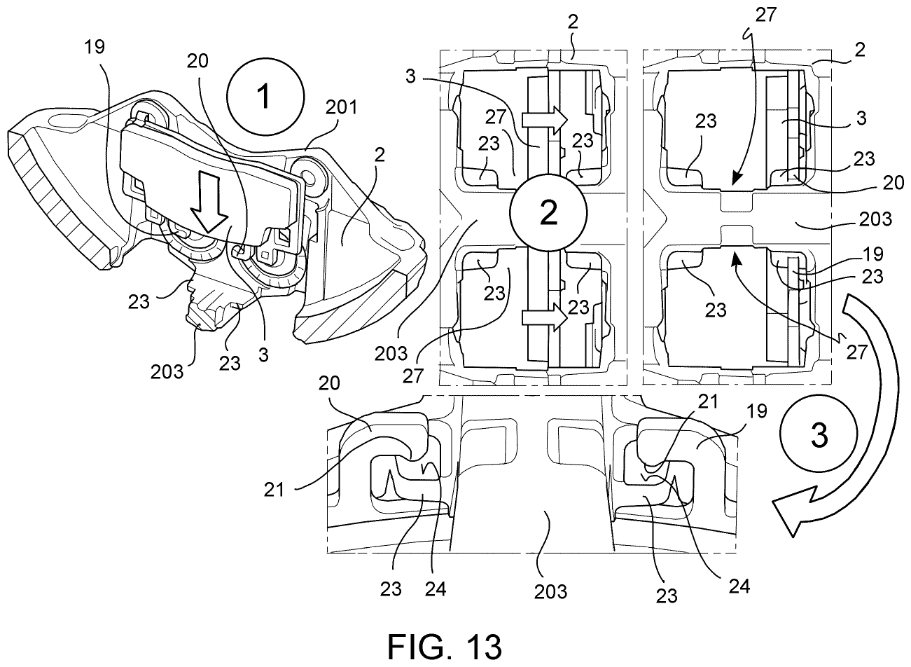

FIG. 14 shows a section view of the caliper in FIG. 1 at the second thrust portions of band spring on a plane containing a radial direction and an axial direction, in which the elastic thrust of the band spring on the brake pads is highlighted.

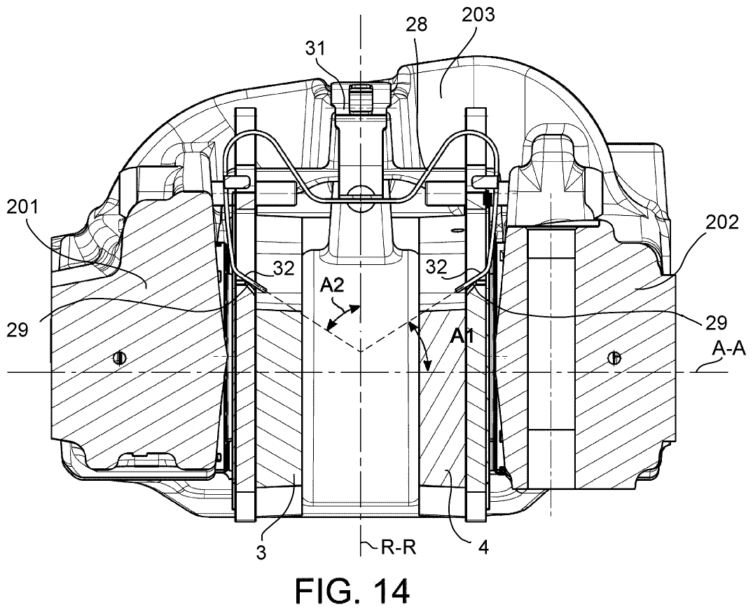

### DESCRIPTION OF SOME PREFERRED EMBODIMENTS

According to a general embodiment of the present invention, an assembly 1 comprises a caliper body 2 and brake pads 3, 4. Said caliper body 2 comprises two pockets 5, 6 which receive the pads 3, 4. The caliper body 2 comprises two elongated elements 201, 202 and at least one central bridge 203 which crosses the two pockets 5, 6. Each brake pad 3, 4 comprises a support plate 11, 12 and friction material 13, 14 of a predetermined radial extension MAR. Each support plate 11, 12 comprises a support plate edge 17 having an upper edge portion 18. Each support plate 11, 12 comprises at least one protuberance 19, 20 which projects from said upper edge portion 18 and is hook-shaped defining a plate sliding surface 21 indirectly facing said rotation axis X-X. Each support plate 11, 12 comprises at least one pad support surface 22 arranged substantially orthogonal to said circumferential direction C-C which extends over at least half of the predetermined radial extension MAR of said friction material 13, 14. Said central bridge 203 comprises at least two central bridge protuberances 23 separated by a central bridge window 27, which form caliper body sliding surfaces 24 which face said plate sliding surfaces 21. The caliper body 2 comprises at least two caliper support surfaces 25, 26 which face said pad support surfaces 22.

According to an embodiment, an assembly 1 comprises a caliper body 2 and brake pads 3, 4.

The caliper body 2 comprises two mutually facing pockets 5, 6 which receive said two brake pads 3, 4 so that, when the caliper body 2 is placed straddling a braking band 7 of a brake disc 8, said brake pads 3, 4 face said opposite braking surfaces 9, 10 of said braking band 7.

Said braking band 7 comprises opposite braking surfaces 9, 10.

Said caliper body 2 comprises a first and a second elongated element 201, 202 that, when the caliper body 2 is placed straddling the braking band 7, face said opposite braking surfaces 9, 10.

Said caliper body 2 comprises at least one central bridge 203 which connects said first and said second elongated elements 201, 202 crossing said two pockets 5, 6.

Said brake disc 8 comprises a rotation axis X-X which defines an axial direction A-A either coinciding with or parallel to said rotation axis X-X, a radial direction R-R orthogonal to said rotation axis X-X, and a circumferential direction C-C orthogonal to said axial direction A-A and said radial direction R-R.

According to an embodiment, said of said brake pads 3, 4 comprises a support plate 11, 12 adapted to support a friction material 13, 14 and support the brake pad 3, 4 to said caliper body 2.

According to an embodiment, said friction material 13, 14 comprises a predetermined radial extension MAR.

According to an embodiment, each support plate 11, 12 comprises a thrust surface 15, an opposite friction material support surface 16, and a support plate edge 17 which connects said thrust surface 15 to said opposite friction material support surface 16.

According to an embodiment, said support plate edge 17 comprises an upper edge portion 18 facing the opposite side with respect to said rotation axis X-X.

According to an embodiment, each support plate 11, 12 comprises at least one protuberance 19, 20 which projects from said upper edge portion 18 of said support plate edge 17 and is hook-shaped defining a plate sliding surface 21.

According to an embodiment, said plate sliding surface 21 substantially and indirectly faces said rotation axis X-X.

According to an embodiment, each support plate 11, 12 comprises at least one pad support surface 22 arranged substantially orthogonal to said circumferential direction C-C.

According to an embodiment, said pad support surface 22 extends over at least ½ of the predetermined radial extent MAR of said friction material 13, 14.

According to an embodiment, said at least one central bridge 203 of caliper body 2 comprises at least two central bridge protuberances 23 forming at least two caliper body sliding surfaces 24 which, when the brake pads 3, 4 are mounted in said caliper body 2, face said plate sliding surfaces 21.

According to an embodiment, said caliper body 2 comprises at least two caliper support surfaces 25, 26 which, when the brake pads 3, 4 are mounted in said caliper body 2, face said pad support surfaces 22.

According to an embodiment, said at least two central bridge protuberances 23 are separated from each other by at least one central bridge window 27 which allows the passage of at least one portion of said at least one protuberance 19, 20 in order to allow each of said at least two support plates 11, 12 to be mounted in said caliper body 2 bringing said plate support surface 21 to face one of said caliper body sliding surfaces 24 and bringing said pad support surface 22 to face one of said caliper support surfaces 25, 26.

According to an embodiment, said plate sliding surface 21 faces said upper edge portion 18 of the support plate edge 17.

According to an embodiment, said plate sliding surface 21 is arranged as an undercut with respect to said support plate protuberance 19, 20.

According to an embodiment, said at least one support plate protuberance 19, 20 is placed radially outside the pad friction material 13, 14 on the opposite side with respect to the rotation axis X-X, when the caliper body 2 is mounted straddling the braking band 7.

According to an embodiment, said at least one pad support surface 22 extends in the radial direction and extends at least as much as said friction material with its predetermined radial extension of friction material MAR.

According to an embodiment, said caliper support surfaces are at least two caliper support surfaces 24, 25 and are arranged on opposite sides, one for each elongated element 201, 202.

According to an embodiment, said caliper body 2 is a body in a single piece. According to an embodiment, said caliper body is made in two pieces, for example joined together be means of studs or bolts.

According to an embodiment, said central bridge 203 of caliper body is a single body with said first and said second elongated elements 201, 202 of caliper body.

According to an embodiment, two support plate protuberances 19, 20 are provided for each support plate 11, 12.

According to an embodiment, two support plate protuberances 19, 20 are provided for each support plate 11, 12 and these two support plate protuberances 19, 20 face each other or are mutually specularly arranged.

According to an embodiment, said central bridge 203 comprises four central bridge protuberances 23, arranged in pairs from opposite orientations of the central bridge 203.

According to an embodiment, said caliper support surface 25, 26 consists of at least two caliper support surfaces 25, 26 each placed to delimit a caliper body pocket 5, 6 to house the respective brake pad 3, 4, delimiting said caliper body pocket 5, 6 which allows the pad to abut against the caliper body 2 during a braking action.

According to an embodiment, said at least one pad support surface 22 consists of two opposite pad support surfaces 22 to allow the brake pad 3, 4 to abut against the caliper body 2 during a forward and reverse braking action of the vehicle which features said caliper body 2.

According to an embodiment, said assembly 1 further comprises at least one band spring 28 shaped to be arranged straddling the brake disc 8 to apply an elastic action to at least one of said brake pads 3, 4 to bias it away from said brake disc 8.

According to an embodiment, said at least one brake pad 3, 4 comprises said support plate 11, 12 which supports said friction material 13, 14, said support plate 11, 12 comprises said plate edge 17 which forms at least one thrust portion 29.

According to an embodiment, said band spring 28 comprises a band-shaped spring body 30.

According to an embodiment, said band spring 28 comprises at least two spring portions 31, 32, at least two of which are mutually distinct, namely
a first coupling portion 31 adapted to couple said band spring 28 to the caliper body 2;
a second thrust portion 32 adapted to apply said elastic action to said thrust portion 29 of said at least one brake pad 3, 4 biasing said brake pad 3, 4 at least away from said brake disc 8 in the axial direction A-A and the radial direction R-R.

According to an embodiment, said at least one band spring 28 comprises a first spring body band 33 comprising a first connection portion 34 from which two first spring arms 35 move away.

According to an embodiment, a second spring body band 36 comprises a second connection portion 37 from which two second spring arms 38 move away.

According to an embodiment, said first connection portion 34 of said first spring body band 33 is connected to said second connection portion 37 of said second spring body band 36 so as to arrange said two first spring arms 35 orthogonal to said two second spring arms 38.

According to an embodiment, said first coupling portion 31 is shaped so as to be snap-coupled to said caliper body 2.

According to an embodiment, said first coupling portion 31 is shaped forming a through-window 39 of first coupling portion.

Said first coupling portion 31 is shaped forming independent arms 40 projecting in a cantilevered fashion when the band spring 28 is not mounted to the caliper body 2.

According to an embodiment, said second thrust portion 32, when supported under operating conditions by said at least one pad 3, 4, is arranged inclined with respect to said axial direction A-A as well as with respect to said radial direction R-R forming a predetermined angle A1 between said second thrust portion 32 and said axial direction A-A and forming a predetermined angle A2 between said second thrust portion 32 and said radial direction R-R.

According to an embodiment, said band spring consist of two band springs 28 placed on either side of the central bridge 203.

The present invention also relates to a method of assembling a brake pad 3, 4 to a brake caliper 2.

This method includes the following steps:
providing an assembly 1 as defined in any one of the embodiments described above;
inserting, substantially in the radial direction R-R, the brake pad 3, 4 into the caliper body 2 on the opposite side of the center bridge 203, by aligning the at least one plate protuberance 19, 20 with the central bridge window 27, so that the plate protuberance 19, 20 goes radially beyond the center bridge protuberances 23;
sliding the brake pad 3, 4 in the axial direction A-A by inserting it into the respective caliper body pocket 5, 6, so that the plate thrust surface 15 thereof faces the caliper body and the at least one plate sliding surface 21 faces the caliper body sliding surface 24 and the at least one pad support surface 22 faces the at least one caliper support surface 25, 26.

According to a further constructional variant of the aforesaid method, there are included the further steps of:
providing a band spring 28 according to any one of claims 11 to 15;
inserting said band spring 28 by snap-coupling said first coupling portion 31 to said caliper body 2 and supporting said second thrust portion 32 on said thrust portion 29 of the plate edge.

### LIST OF REFERENCE SIGNS

1 caliper body assembly
2 caliper body
3 brake pad
4 brake pad
5 pocket in caliper body for housing brake pad
6 pocket in caliper body for housing brake pad
7 braking band
8 brake disc
9 braking band braking surface
10 braking band braking surface
11 pad support plate
12 pad support plate
13 pad friction material
14 pad friction material
15 plate thrust surface
16 friction material support surface of plate
17 support plate edge
18 upper edge portion of support plate edge
19 support plate protuberance
20 support plate protuberance
21 plate sliding surface
22 pad support surface
23 central bridge protuberance
24 caliper body sliding surface
25 caliper support surface
26 caliper support surface
27 central bridge window
28 band spring
29 thrust portion of support plate edge
30 band-shaped spring body
31 first spring coupling portion
32 second spring thrust portion
33 first spring body band
34 first spring connection portion
35 first spring arms
36 second spring body band
37 second connection portion
38 second spring arms
39 through-window of first coupling portion
40 independent arms
201 first elongated element of caliper body
202 second elongated element of caliper body
203 central bridge of caliper body
X-X rotation and symmetry axis of disc brake disc
A_A axial direction
R-R radial direction
C-C C circumferential direction
MAR radial extension of the pad friction material

1. An assembly (1) of caliper body (2) and brake pads (3, 4), wherein
the caliper body (2) comprises two pockets (5, 6) facing each other, which receive said two brake pads (3, 4) so that, when the caliper body (2) is placed straddling a braking band (7) of a brake disc (8), where said braking band (7) comprises opposite braking surfaces (9, 10), said brake pads (3, 4) face said opposite braking surfaces (9, 10) of said braking band (7); and wherein
said caliper body (2) comprises a first and a second elongated element (201, 202), which, when the caliper body (2) is placed straddling the braking band (7), face said opposite braking surfaces (9, 10); and wherein
said caliper body (2) comprises at least one central bridge (203) which connects said first and said second elongated elements (201, 202) crossing said two pockets (5, 6);
said brake disc (8) comprises a rotation axis (X-X), which defines an axial direction (A-A), either coinciding with or parallel to said rotation axis (X-X), a radial direction (R-R) orthogonal to said rotation axis (X-X), and a circumferential direction (C-C) orthogonal to said axial direction (A-A) and said radial direction (R-R);
each of said brake pads (3, 4) comprises a support plate (11, 12) adapted to support a friction material (13, 14) and support the brake pad (3, 4) at said caliper body (2); and wherein said friction material (13, 14) comprises a predetermined radial extension (MAR);
each support plate (11, 12) comprises a thrust surface (15), an opposite friction material support surface (16), and a support plate edge (17), which connects said thrust surface (15) to said opposite friction material support surface (16); and wherein
said support plate edge (17) comprises an upper edge portion (18) facing the opposite side with respect to said rotation axis (XX); and wherein
each support plate (11, 12) comprises at least one protuberance (19, 20) projecting from said upper edge portion (18) of said support plate edge (17) and is hook-shaped defining a plate sliding surface (21); wherein said plate sliding surface (21) substantially faces said rotation axis (X-X) indirectly;
each support plate (11, 12) comprises at least one pad support surface (22) arranged substantially orthogonal to said circumferential direction (C-C); wherein said pad support surface (22) extends over at least ½ of the predetermined radial extension (MAR) of said friction material (13, 14); and wherein
said at least one central bridge (203) of caliper body (2) comprises at least two central bridge protuberances (23) forming at least two caliper body sliding surfaces (24) which, when the brake pads (3, 4) are mounted in said caliper body (2), face said plate sliding surfaces (21); and wherein
said caliper body (2) comprises at least two caliper support surfaces (25, 26) which, when the brake pads (3, 4) are mounted in said caliper body (2), face said pad support surfaces (22);
said at least two central bridge protuberances (23) are separated from each other by at least one central bridge window (27) which allows at least one portion of said at least one bridge protuberance (19, 20) to pass in order to allow mounting each of said at least two support plates (11, 12) in said caliper body (2) bringing said plate resting surface (21) to face one of said caliper body sliding surfaces (24) and bringing said pad support surface (22) to face one of said caliper support surfaces (25, 26).

2. An assembly (1) according to claim 1, wherein
said plate sliding surface (21) faces said upper edge portion (18) of the support plate edge (17);
or wherein
said plate sliding surface (21) is arranged as an undercut with respect to said plate support protuberance (19, 20).

3. An assembly (1) according to claim 1, wherein
said at least one support plate protuberance (19, 20) is placed radially outside the pad friction material (13, 14) on the opposite side with respect to the rotation axis (X-X) when the caliper body (2) is mounted straddling the braking band (7).

4. An assembly (1) according to claim 1, wherein
said at least one pad support surface (22) extends in the radial direction and extends at least as much as said friction material with the predetermined radial extension of friction material (MAR).

5. An assembly (1) according to claim 1, wherein
said caliper support surfaces are at least two caliper support surfaces (24, 25) and are arranged on opposite sides, one for each elongated element (201, 202).

6. An assembly (1) according to claim 1, wherein
said caliper body (2) is a one-piece body;
or wherein
said caliper body (2) is made in two parts;
or wherein
said central bridge (203) of caliper body is a single body with said first and said second elongated elements (201, 202) of caliper body.

7. An assembly (1) according to claim 1, wherein
two support plate protuberances (19, 20) are provided for each support plate (11, 12);
or wherein
two support plate protuberances (19, 20) are provided for each support plate (11, 12), and these two support plate protuberances (19, 20) face each other or are mutually specularly arranged.

8. An assembly (1) according to claim 1, wherein
said central bridge (203) comprises four central bridge protuberances (23), arranged in pairs from opposite orientations of the central bridge (203).

9. An assembly (1) according to claim 1, wherein
said caliper support surface (25, 26) consists of at least two caliper support surfaces (25, 26) each placed to delimit a caliper body pocket (5, 6) to house the respective brake pad (3, 4), delimiting said caliper body pocket (5,6) which allows the pad to abut against the caliper body (2) during a braking action.

10. An assembly (1) according to claim 1, wherein
said at least one pad support surface (22) consists of two opposite pad support surfaces (22) to allow the brake pad (3, 4) to abut against the caliper body (2) during a forward and reverse braking action of the vehicle which features said caliper body (2).

11. An assembly (1) according to claim 1, wherein
said assembly (1) further comprises at least one band spring (28) shaped to be arranged straddling the brake disc (8) to apply an elastic action to at least one of said brake pads (3, 4) to bias it away from said brake disc (8); wherein
said at least one brake pad (3, 4) comprises said support plate (11, 12), which supports said friction material (13, 14), said support plate (11, 12) comprises said plate edge (17) which forms at least one thrust portion (29);
said band spring (28) comprises a band-shaped spring body (30);
said band spring (28) comprises at least two spring portions (31, 32) at least two of which are mutually distinct, namely
a first coupling portion (31) adapted to couple said band spring (28) to the caliper body (2);
a second thrust portion (32) adapted to apply said elastic action to said thrust portion (29) of said at least one brake pad (3, 4) biasing said brake pad (3, 4) at least away from said brake disc (8) in an axial direction (A-A) and a radial direction (R-R).

12. An assembly (1) according to claim 11, wherein
at least one band spring (28) comprises a first spring body band (33) comprising a first connection portion (34) from which two first spring arms (35) move away; and wherein a second spring body band (36) comprising a second connection portion (37) from which two second spring arms (38) move away; and wherein
said first connection portion (34) of said first spring body band (33) is connected to said second connection portion (37) of said second spring body band (36) to arrange said two first spring arms (35) orthogonal to said two second spring arms (38).

13. An assembly (1) according to claim 11, wherein
said first coupling portion (31) is shaped so as to be snap coupled to said caliper body (2);
and/or wherein
said first coupling portion (31) is shaped forming a through-window of the first coupling portion (39);
or wherein
said first coupling portion (31) is shaped forming independent arms (40) overhangingly projecting when the band spring (28) is not mounted to the caliper body (2).

14. An assembly (1) according to claim 11, wherein
said second thrust portion (32), when resting onto said at least one pad (3, 4) in operating conditions, is arranged to be inclined with respect to said axial direction (A-A) as well as with respect to said radial direction (R-R), forming a predetermined angle (A1) between said second thrust portion (32) and said axial direction (A-A) and forming a predetermined angle (A2) between said second thrust portion (32) and said radial direction (R-R).

15. An assembly (1) according to claim 11, wherein
said band spring consist of two band springs (28) placed on either side of the central bridge (203).

16. A method of mounting a brake pad (3, 4) to a caliper body (2), wherein the following steps are comprised:
providing an assembly (1) according to claim 1;
inserting substantially in the radial direction (R-R) the brake pad (3, 4) into the caliper body (2) on the opposite side of the center bridge (203), aligning the at least one plate protuberance (19, 20) with the central bridge window (27), so that the plate protuberance (19, 20) passes radially beyond the center bridge protuberances (23);
sliding the brake pad (3, 4) in the axial direction (A-A) by inserting it into the respective caliper body pocket (5, 6), so that the plate thrust surface (15) thereof faces the caliper body and the at least one plate thrust surface (21) faces the caliper body sliding surface (24) and the at least one pad support surface (22) faces the at least one caliper support surface (25, 26).

17. A method according to claim 16, wherein there are comprised the further steps of:
providing a band spring (28) shaped to be arranged straddling the brake disc (8) to apply an elastic action to at least one of said brake pads (3, 4) to bias it away from said brake disc (8); wherein
said at least one brake pad (3, 4) comprises said support plate (11, 12), which supports said friction material (13, 14), said support plate (11, 12) comprises said plate edge (17) which forms at least one thrust portion (29);
said band spring (28) comprises a band-shaped spring body (30);
said band spring (28) comprises at least two spring portions (31, 32) at least two of which are mutually distinct, namely
a first coupling portion (31) adapted to couple said band spring (28) to the caliper body (2);
a second thrust portion (32) adapted to apply said elastic action to said thrust portion (29) of said at least one brake pad (3, 4) biasing said brake pad (3, 4) at least away from said brake disc (8) in an axial direction (A-A) and a radial direction (R-R);
inserting said band spring (28) by snap-coupling said first coupling portion (31) to said caliper body (2) and supporting said second thrust portion (32) on said thrust portion (29) of the plate edge.
